(19) United States
(12) Patent Application Publication
(10) Pub. No.: US 2011/0017965 A1
(43) Pub. Date: Jan. 27, 2011

(54) Fence and Rail Assemblies and Methods of Forming the Same

(76) Inventor: Frank Kowalewicz, Rochester Hills, MI (US)

Correspondence Address: McPherson IP Law Office PLLC, P.O. Box 81876, Rochester, MI, 48308, US

(21) Appl. No.: 12/842,007

(22) Filed: Jul. 22, 2010

Related U.S. Application Data
(60) Provisional application No. 61/228,098, filed on Jul. 23, 2009.

(51) Int. Cl. E04H 17/16; B23P 17/00

(52) U.S. Cl. 256/19; 256/24; 29/527.2

(57) ABSTRACT

The present invention relates to fence and railing, and methods of forming the same, having improved attachment means for panels. In one aspect, the present invention provides a transparent fence or rail assembly. The transparent fence or rail assembly includes a transparent panel having a first edge and a second edge. The transparent fence or rail assembly also includes a first frame member extending along the first edge of the transparent panel, the first frame member being fixedly attached to the transparent panel with a first adhesive, and a second frame member extending along the second edge of the transparent panel, the second frame member being fixedly attached to the transparent panel with a second adhesive, wherein the transparent fence or rail assembly requires no additional attachment feature for maintaining the position of the transparent panel with respect to the first frame member and second frame member.

### CROSS-REFERENCE TO RELATED APPLICATION

The present application claims benefit of U.S. Provisional Patent Application No. 61/228,098, filed Jul. 23, 2009, the contents of which are hereby incorporated by reference in its entirety for all purposes.

### FIELD OF THE INVENTION

The present invention relates to fence and railing, and methods of forming the same, having improved attachment means for panels thereof.

### BACKGROUND

Fence and railings are particularly useful devices for forming sectioned areas for safety or otherwise. In certain situations, it is particularly desirous to form fencing that is rigid to prevent persons and items from unintentionally going through such fences. Rigid fences include posts that are rigidly mounted to a floor surface or ground and extend to a particular height to prevent items or persons from going thereover. To ensure that the persons or items stay within the sectioned area, vertical members, horizontal members, mesh, panels, combinations thereof or otherwise are disposed between the posts.

In one particular configuration, it is desirous to provide fencing that is transparent or semi-transparent for viewing therethrough. Such transparent fencing is particularly advantageous in industrial applications where dangerous conditions may exist. These transparent fences are also particularly desirous in areas having aesthetically pleasing surroundings, such as decks, patios, boardwalks or otherwise.

In one particular configuration, transparent fences are formed through the use of transparent panels, such as glass, extending between post members of the fence. Current transparent panels are attached to frame members of the fence, such as posts or cross members joining the posts, through decorative attachment hardware such as clips or brackets. Such attachment hardware is mounted to frame members of the fence, typically through fasteners, and are configured to support the transparent panels.

However, current attachment hardware for fence panels are time consuming in use and perhaps to a greater extent are expensive. For example, the use of current attachment hardware requires modification of the frame members for attachment of the hardware to the fence, such as through threaded fasteners or other mechanical means. Further, certain attachment hardware requires the drilling of holes through the panels thereby resulting in additional assembly time and/or cost. Given the fact that it is conceivable that 4 or more attachment means are used per panel and that a single fence assembly may include 6, 12, 18 or more panels, a large cost of the installation is related to assembly. With respect to hardware cost, it is not uncommon for each attachment hardware component to cost $5 to $10, or more. Again, with the foreseeable number of attachment components that may be required, per panel, considerable cost is added to the installation project.

In another aspect, certain attachment hardware are prone to discoloration, due to the natural oxidation of the metal forming the hardware. During rain or other precipitation, the oxidized material flows over the glass causing staining thereto. Plastic and other non-metallic attachment hardware causes potential safety issues as they may break due to blunt forces or deterioration over time. Also, the drilling of holes into preformed glass may result in cracks or other imperfection formed about the holes further resulting in a reduction of strength to the glass. Still further, depending upon the configuration of the attachment hardware, maintenance may be required to ensure that the hardware, or fasteners thereof, do not become loose due to the expansion and contraction of the frame members, panels, hardware or combinations thereof.

In view of the foregoing, there is a need for an improved fence assembly, and method of forming the same, that reduces installation time, is lower in cost, has little to no maintenance and is reliable over the life of the fence assembly.

### SUMMARY OF THE INVENTION

The present invention overcomes the problems encountered with previous fence assemblies by providing improved transparent fences and rail assemblies, and method of forming the same, using improved attachment means. While the description herein primarily references fences, it should be appreciated that the teachings of the present invention may be equally applied to railings or other barriers.

In one aspect, the present invention provides a transparent fence assembly. The transparent fence assembly includes a transparent panel having a first edge and a second edge. The transparent fence assembly also includes a first frame member extending along the first edge of the transparent panel, the first frame member being fixedly attached to the transparent panel with a first adhesive, and a second frame member extending along the second edge of the transparent panel, the second frame member being fixedly attached to the transparent panel with a second adhesive.

In another aspect, the present invention provides a transparent fence assembly. The transparent fence assembly includes a first vertical fence post and a second vertical fence post. The first and second vertical fence posts are disposed apart with respect to one another. The transparent fence assembly also includes a first horizontal fence member connecting a top portion of the first vertical fence post to a top portion of the second vertical fence post. The first horizontal fence member has a first abutment extending along a length of the first horizontal fence member. The transparent fence assembly further includes a second horizontal fence member connecting a bottom portion of the first vertical fence post to a bottom portion of the second vertical fence post. The second horizontal fence member has a second abutment and a support member extending along a length of the second horizontal fence member. The transparent fence assembly still further includes a transparent glass panel disposed between the first vertical fence post and the second vertical fence post. The transparent glass panel has a top edge disposed adjacent the first abutment and a bottom edge disposed adjacent the second abutment. The transparent fence assembly also includes a first two-sided adhesive foam strip disposed between the top edge of the transparent glass panel and the first abutment. The first two-sided adhesive foam strip attaches the top edge of the transparent glass panel to the first abutment. The transparent fence assembly further includes a second two-sided adhesive foam strip disposed between the bottom edge of the transparent glass panel and the second abutment. The second two-sided adhesive foam strip attaches the bottom edge of the transparent glass panel to the second abutment. The transparent fence assembly further includes a first fascia disposed along the top edge of the transparent glass panel opposite the first abutment and attached to the top edge of the transparent glass panel with a third two-sided adhesive foam strip. The transparent fence assembly further includes a second fascia disposed along the bottom edge of the transparent glass panel opposite the second abutment and attached to the bottom edge of the transparent glass panel with a fourth two-sided adhesive foam strip. An expansion member is disposed between the support of the second horizontal fence member and the transparent glass panel, wherein the transparent fence assembly requires no additional attachment feature for maintaining the position of the transparent panel with respect to the first frame member and second frame member.

In still another aspect, the present invention provides a method of forming a transparent fence assembly. The method includes attaching a first horizontal fence member to a top portion of a first vertical fence post and a second vertical fence post, the first horizontal fence member includes a first abutment. The method further includes attaching a second horizontal fence member to a bottom portion of the first vertical fence post and the second vertical fence post, the second horizontal fence member includes a second abutment. A first two-sided adhesive foam strip is adhered to the first abutment and a second two-sided adhesive foam strip is adhered to the second abutment. The method also includes attaching a transparent glass panel to the first and second horizontal fence member through the first and second two-sided adhesive foam strip, wherein the transparent fence assembly requires no additional attachment features for maintaining the position of the transparent panel with respect to the first horizontal frame member and second horizontal frame member.

The above-described and other features and advantages of the present invention will be appreciated and understood by those skilled in the art from the following detailed description, drawings, and appended claims.

### BRIEF DESCRIPTION OF THE DRAWINGS

Other objects, features, advantages and details of the present invention appear, by way of example only, in the following detailed description of preferred embodiments of the invention, the detailed description referring to the drawings in which:

FIG. 1 illustrates a perspective view of a fence assembly according to the teachings of the present invention;

FIG. 2 illustrates an elevational front view of a fence assembly section according to the teachings of the present invention;

FIG. 3 illustrates a cross-sectional view of an upper horizontal fence member shown in FIG. 2;

FIG. 4 illustrates a cross-sectional view of a lower horizontal fence member shown in FIG. 2;

FIG. 5 illustrates a perspective view of an exemplary embodiment of a central frame member according to the teachings of the present invention;

FIG. 6 illustrates an end view of the central frame member shown in FIG. 6;

FIG. 7 illustrates a perspective view of an exemplary embodiment of a fascia member according to the teachings of the present invention; and

FIG. 8 illustrates an end view of the fascia member shown in FIG. 7.

### DESCRIPTION OF THE PREFERRED EMBODIMENTS

The present invention relates to fence and railing, and methods of forming the same, having improved attachment means for panels. In one configuration, the improved attachment is derived through the use of adhesives, and in one particular configuration two-sided adhesive foam strips. Through the features of the present invention, improved fence and rail assemblies are formed having increased reliability and lower installation costs. Further, through the use of adhesives, mechanical fasteners are no longer required for attachment of the panel, transparent or otherwise, to the frame members of the fence or rail assembly.

The fence and rail assemblies of the present invention are useable in various applications, both commercial and residential, including, without limitation, fences, railings, gates or other barriers in industrial settings, shopping centers, malls, stadiums, theaters, boardwalks, residential applications such as balconies and decks, or otherwise. Other specific applications include commercial and residential aluminum guardrails, aluminum handrails, balcony railings, deck railings, porch railings, ramp railings, stair railings, or retaining wall railings. Still other specific applications include gates such as walk gates, driveway gates, privacy gates, pool safety gates or other gates. In one application, the fence assemblies of the present invention are particularly useful in applications where transparent barriers are desired, such as for safety or aesthetic purposes. It should be appreciated that fences are commonly used to form barriers and rails while also used to form barriers further require certain certificates of strength and/or performance to ensure safety or other satisfaction requirements. It should also be appreciated that other applications are possible and are within the scope of the present invention.

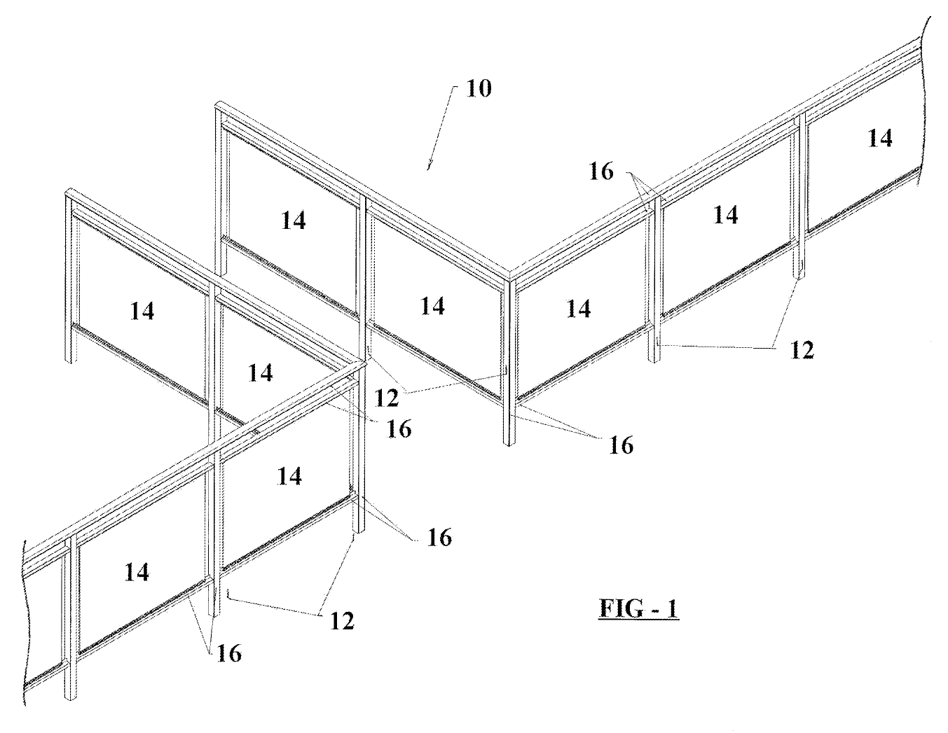

Referring to FIG. 1, an exemplary embodiment of a fence assembly 10 is shown. In this embodiment, multiple fence sections 12 are joined together to form the overall fence assembly 10. However, it should be appreciated that the fence assembly may comprise a single fence section 12. The fence sections 12 include one or more panels 14 extending between two or more frame members 16 that are suitable in strength for supporting, directly or indirectly, the one or more panels 14. The panels 14 supported by the frame members 16 may be transparent or opaque. However, in one preferred embodiment, one or more panels 14 of the fence assembly 10 comprise transparent panels.

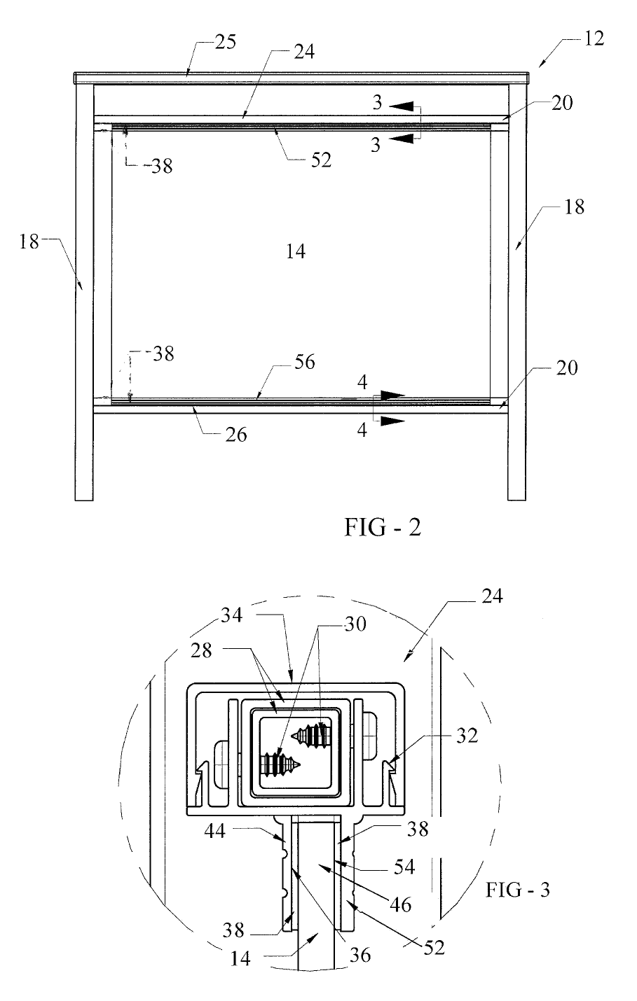

Referring to FIG. 2, the one or more panels 14 may extend between two vertical frame members 16, e.g. fence post 18, two horizontal frame members, e.g., fence members 20, or both. To this extent, it is contemplated that the vertical fence post 18, horizontal fence members 20, or both, are directly attached to the one or more panels 14 and configured to provide support thereto. In one preferred configuration, the frame members 16 are configured for engagement with the panels and more particularly adhesive attachment to the panels 14. To this end, the frame members 16 are configured for receiving an adhesive and attachment to the panel 14, as discussed in greater detail below.

As shown in FIGS. 2 through 4, the horizontal fence members 20 comprise an upper horizontal fence member 24 and a lower horizontal fence member 26. The upper and lower horizontal fence members 24, 26 are attached to the fence post 18 using any suitable means. In one configuration, the upper and lower horizontal fence members 24, 26, or portions thereof, are received within openings formed by the fence post 18, which act to maintain the position of the fence members 24, 26 with respect to the fence post 18. Attachment or positioning of horizontal fence members 20 with the fence posts 18 may be achieved through fasteners or otherwise. It is contemplated that the upper horizontal fence member 24 may comprise a hand rail. Alternatively, the fence assembly may include a separate hand rail 25 attached to the vertical fence posts 18.

In greater detail, referring to FIGS. 3 and 4, the upper and lower horizontal fence members 24, 26 includes central frame members 27 that are attached to one or more central frame supports 28, via one or more fasteners 30, which act to provide additional support to the upper and lower horizontal fence members 24, 26 and optionally facilitate in attachment of the horizontal fence members 20 to the fence posts 18. The central frame members 27 include one or more snap-fittings 32 configured for engagement with a decorative cap 34, which covers the one or more central frame supports 28.

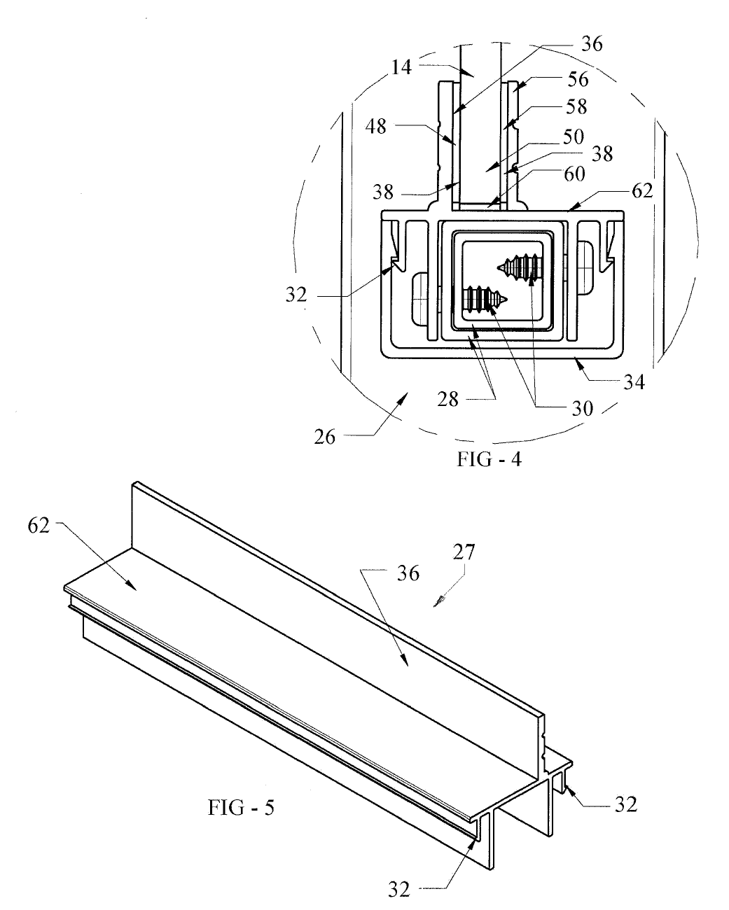

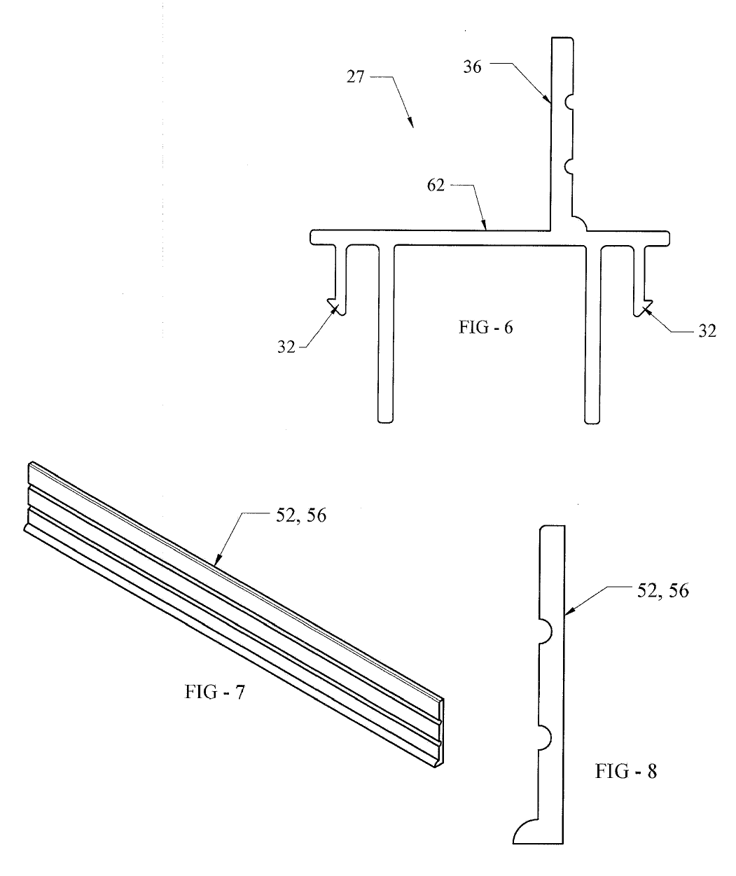

As previously mentioned, the frame members may be configured for adhesive attachment to panel 14. In one configuration, with reference to FIGS. 5 and 6, the horizontal fence members 20 are shown including engagement surfaces 36 for receiving an adhesive 38, see FIGS. 3 and 4. Referring again to FIGS. 5 and 6, in this configuration, the engagement surface 36 is substantially flat and acts as an abutment for keeping the panel from sliding through the fence assembly 10. The horizontal fence member 20 also includes a support surface for providing optional support for the weight of the panel 14.

The adhesive 38 used for attachment of panel 14 to the horizontal fence members 20, via engagement surface 36, may comprise any suitable adhesive configured for bonding to the particular materials forming the panel 14 and frame members 16. A preferred adhesive 38 would also be suitable in strength to maintain the panel attached to the frame members through various environmental conditions commonly encountered by fence assemblies. Still further, in one preferred embodiment, the adhesive is easy to install during assembly of the fence assembly, and relatively low in cost.

In one exemplary embodiment, the adhesive 38 comprises a two-sided adhesive tape or strip, and in one particularly preferred configuration a two-sided adhesive foam tape or strip. The two-sided adhesive tape may comprise a continuous strip substantially extending the length of the horizontal fence members. Alternatively, the two-sided adhesive tape may comprise a plurality of strips placed along the length of the horizontal fence members.

In either regards, in one embodiment, a first side of an adhesive strip 38 is applied to the engagement surface 36 of the frame member 16, optionally after removing a protective coating or cover. A second side of the adhesive strip 38 is applied to the panel, optionally after removing a protective coating or cover. In this configuration, a first adhesive strip 44 is attached to the engagement surface 36 of the upper horizontal fence member 24 and a top edge 46 of the panel. A first side of a second adhesive strip 48 is attached to the engagement surface 36 of the lower horizontal fence member 26 and a second side of the second adhesive strip is attached to a bottom edge 50 of the panel 14, in a similar manner to that of the first adhesive strip 38.

In one exemplary embodiment, a first fascia 52 is attached to the top edge 46 of the panel 14, opposite the first adhesive strip 44, via another adhesive such as a third two-sided adhesive strip 54. Similarly, a second fascia 56 is attached to the bottom edge 50 of the panel 14, opposite the second adhesive strip 48, via another adhesive such as a fourth two-sided adhesive strip 58. Also, a flexible member, such as a gasket 60, may be placed between a support surface 62 of the lower horizontal fence member 26 and the panel 14.

In one exemplary embodiment, the two-sided adhesive foam tape or strips 38 is formed of a base foam material having layers of adhesive on both sides of the base foam. Alternatively, the form material may comprise an adhesive material. In any regard, a suitable adhesive is preferably configured to be adaptive to the surrounding conditions. For example, a preferred adhesive is resistant to moisture, resistant to peeling and is suitable in strength (e.g. shear and stress) to support and maintain a panel member weighing 10 lb, 20 lb 30 lb or more against a frame member. A preferred adhesive is also resistant to plastic migration at elevated temperatures, such as temperatures of 100° F. or more. In one embodiment, the adhesive strip is also viscoelastic in nature and configured to provide shock absorbing capabilities. One suitable viscoelastic material comprises a foam, such as, without limitation, acrylic, urethane and vinyl foam. It is contemplated that the adhesive and/or foam material may comprise a thickness of, and/or greater than, about 1/32 of an inch, 1/16 of an inch, ⅛ of an inch, ¼ of an inch or otherwise. Specific suitable adhesives tapes are provided by 3M™ United States, of St. Paul, Minn., and can be under the tradename VHB™ Tapes and Single-Coated Foam Tapes (4100, 4300, 4500 and 4700 series). It should be appreciated that other adhesive tapes and strips are available.

The frame members 16 forming the fence of fence assembly may be formed of any suitable material and may include any particularly preferred coating, particularly materials and coatings that are useable with the adhesives described herein. In one non-limiting configuration, the frame members 16 are formed of aluminum and include enamel or zinc powder coating.

The panels 14 may also be formed of any suitable material useable with the adhesives described herein. Accordingly, it is contemplated that in one exemplary embodiment the panels are substantially free of holes or other engagement features configured for use with mechanical fasteners, such as threaded fasteners or otherwise. However, in a preferred configuration the material forming the panels 14 are transparent and suitable in strength to maintain persons or items within the fenced area. One particularly suitable material comprises glass, though plastics are possible as well. The glass may include a thickness of between about ⅛″ to ½″, or otherwise. However, the thickness may vary to meet strength requirements for the panel, whether glass or other material. Further it is contemplated that the glass may be coated and/or treated (e.g., tempered or otherwise) to improve strength and safety, or to provide tinting or other aesthetic desires. It is contemplated that a solvent and/or primer may be used to improve adhesion between the adhesive 38, frame members 16 and panel 14.

Other panel configurations are also contemplated for use with the teachings of the present invention. For example, the panel of the present invention may include infill transparent panels, semi-transparent panels, opaque panels or otherwise. These panels may be formed of glass, Plexiglas, wire mesh, solid or perforated infill, casting or decorative designs. It should be appreciated that other configuration are available. Accordingly, it is further contemplated that the panel may be formed of other materials such as metal, e.g. steel, aluminum, iron or otherwise, and may also include a suitable coating, such as the coating described with frame members 16 or otherwise.

The present invention further contemplates a method of forming a fence assembly. In one exemplary embodiment, the method includes mounting a first and second vertical fence member 18 to a ground or a structure to form a rigid mounting structure. An upper horizontal fence member 24 is attached to a top portion of the first and second vertical fence members 18 and a lower horizontal fence member 26 is attached to the bottom portion of the first and second vertical fence members 18. A first two-sided adhesive strip 44 is attached to the engagement surface 36 of the upper horizontal fence member 24 and a second two-sided adhesive strip 48 is attached to the engagement surface of the lower horizontal fence member 26. The panel 14 is then attached to the upper and lower horizontal fence members 24, 26, via the first and second two-sided adhesive strips 44, 48, at an upper and lower edge 46, 50 of the panel 14, respectively. In one particular exemplary embodiment, a third two-sided adhesive strip 54 is attached to the upper edge 46 of the panel 14, opposite the first two-sided adhesive strip 44, and a fourth two-sided adhesive strip 58 is attached to the lower edge 50 of the panel 14, opposite the second two-sided adhesive strip 48. A first fascia 52 is attached to the panel 14, via the third two-sided adhesive strip 54, and a second fascia 56 is attached to the panel 14, via the fourth two-sided adhesive strip 58. Other steps are completed as shown and described herein.

While the invention has been described with reference to a preferred embodiment, e.g. fences, it will be understood by those skilled in the art that various changes may be made and equivalents may be substituted for elements thereof without departing from the scope of the invention. Accordingly, such embodiments further include rails, gates or other barriers. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A transparent fence or rail assembly, comprising:
a transparent panel having a first edge and a second edge;
a first frame member extending along the first edge of the transparent panel, the first frame member being fixedly attached to the transparent panel with a first adhesive; and
a second frame member extending along the second edge of the transparent panel, the second frame member being fixedly attached to the transparent panel with a second adhesive.

2. The transparent fence or rail assembly of claim 1, wherein the transparent fence or rail assembly requires no additional attachment feature for maintaining the position of the transparent panel with respect to the first frame member and second frame member.

3. The transparent fence or rail assembly of claim 1, wherein the first adhesive comprises a two-sided adhesive foam strip extending along the first edge of the transparent panel.

4. The transparent fence or rail assembly of claim 3, wherein the second adhesive comprises a two-sided adhesive foam strip extending along the second edge of the transparent panel.

5. The transparent fence or rail assembly of claim 4, wherein the first and second adhesive adheres to both glass and metal.

6. The transparent fence or rail assembly of claim 1, wherein the first and second two-sided adhesive foam strip includes acrylic foam, vinyl foam or polyurethane foam.

7. The transparent fence or rail assembly of claim 1, wherein the first frame member comprises an upper horizontal frame member and the second frame member comprises a lower horizontal frame member, the first and second frame members are supported by a first vertical frame member and a second vertical frame member.

8. The transparent fence or rail assembly of claim 7, further comprising a first fascia extending along the first edge of the transparent panel, the first fascia being fixedly attached to the transparent panel with a third adhesive, wherein attachment of the first fascia to the transparent panel is substantially free of mechanical fasteners.

9. The transparent fence or rail assembly of claim 8, further comprising a second fascia extending along the second edge of the transparent panel, the second fascia being fixedly attached to the transparent panel with a fourth adhesive, wherein attachment of the second fascia to the transparent panel is substantially free of mechanical fasteners.

10. The transparent fence or rail assembly of claim 1, wherein the transparent panel comprises glass.

11. The transparent fence or rail assembly of claim 1, wherein the transparent panel comprises plastic.

12. The transparent fence or rail assembly of claim 1, wherein the first frame member includes a first abutment, the first adhesive being attached directly to the first abutment and transparent panel.

13. The transparent fence or rail assembly of claim 1, wherein the second frame member includes a second abutment, the second adhesive being attached directly to the second abutment and transparent panel.

14. The transparent fence or rail assembly of claim 13, wherein the second frame member further includes a support member for supporting at least a portion of the weight of the transparent panel.

15. The transparent fence or rail assembly of claim 14, further comprising an expansion member disposed between the support member and the transparent panel.

16. The transparent fence or rail assembly of claim 1, wherein the expansion member comprises a rubber seal.

17. A transparent fence or rail assembly, comprising:
a first vertical post and a second vertical post, the first and second vertical post being disposed apart with respect to one another;
a first horizontal member connecting a top portion of the first vertical post to a top portion of the second vertical post, the first horizontal member having a first abutment extending along a length of the first horizontal member;
a second horizontal member connecting a bottom portion of the first vertical post to a bottom portion of the second vertical post, the second horizontal member having a second abutment and a support member extending along a length of the second horizontal member;
a transparent glass panel disposed between the first vertical post and the second vertical post, the transparent glass panel having a top edge disposed adjacent the first abutment and a bottom edge disposed adjacent the second abutment;
a first two-sided adhesive foam strip disposed between the top edge of the transparent glass panel and the first abutment, the first two-sided adhesive foam strip attaching the top edge of the transparent glass panel to the first abutment;
a second two-sided adhesive foam strip disposed between the bottom edge of the transparent glass panel and the second abutment, the second two-sided adhesive foam strip attaching the bottom edge of the transparent glass panel to the second abutment;
a first fascia disposed along the top edge of the transparent glass panel opposite the first abutment and attached to the top edge of the transparent glass panel with a third two-sided adhesive foam strip; and
a second fascia disposed along the bottom edge of the transparent glass panel opposite the second abutment and attached to the bottom edge of the transparent glass panel with a fourth two-sided adhesive foam strip; and
an expansion member disposed between the support member of the second horizontal member and the transparent glass panel,
wherein the transparent or rail assembly requires no additional attachment feature for maintaining the position of the transparent panel with respect to the first horizontal frame member and second horizontal frame member.

18. A method of forming a transparent fence or rail assembly, comprising:
attaching a first horizontal member to a top portion of a first vertical post and a second vertical post, the first horizontal member including a first abutment;
attaching a second horizontal member to a bottom portion of the first vertical post and the second vertical post, the second horizontal member including a second abutment;
adhering a first two-sided adhesive foam strip to the first abutment and a second two-sided adhesive foam strip to the second abutment; and
attaching a transparent glass panel to the first and second horizontal member through the first and second two-sided adhesive foam strip,
wherein the transparent fence or rail assembly does not require additional attachment features for maintaining the position of the transparent panel with respect to the first horizontal frame member and second horizontal frame member.

19. The method of claim 18, wherein the second horizontal frame member further includes a support member for supporting at least a portion of the weight of the transparent glass panel.

20. The method of claim 19, further comprising disposing an expansion member between the support member and the transparent glass panel.
